(19) United States
(12) Patent Application Publication
(10) Pub. No.: US 2009/0028711 A1
(43) Pub. Date: Jan. 29, 2009

(54) METHOD FOR THE INDUCTIVE HIGH-FREQUENCY PRESSURE WELDING OF METALLIC STRUCTURAL ELEMENTS USING AT LEAST TWO DIFFERENT FREQUENCIES AND COMPONENT PRODUCED BY SAID METHOD

(76) Inventors: Herbert Hanrieder, Hohenkammer (DE); Alexander Gindorf, Schwabhausen (DE)

Correspondence Address: MCANDREWS HELD & MALLOY, LTD, 500 WEST MADISON STREET, SUITE 3400, CHICAGO, IL, 60661, US

(21) Appl. No.: 12/233,223

(22) Filed: Sep. 18, 2008

Related U.S. Application Data
(63) Continuation of application No. PCT/DE2007/000454, filed on Mar. 14, 2007.

(30) Foreign Application Priority Data
Mar. 20, 2006 (DE) 10 2006 012 661.0
Mar. 14, 2007 (DE) PCT/DE2007/000454

(51) Int. Cl. B23K 13/01; F01D 5/30

(52) U.S. Cl. 416/213 R; 219/617

(57) ABSTRACT

The present technology relates to a method for connecting metallic structural components, especially structural components of a gas turbine, wherein the connection of corresponding connecting surfaces of the construction elements occurs by means of an inductive high-frequency pressure welding with heating of at least one connecting surface. According to the present technology, at least two different frequencies induced by at least one inductor are used for heating the at least one connecting surface. The present technology also relates to a component, especially a component of a gas turbine consisting of a first structural element and a second structural element, whereby the first and the second structural elements are welded by means of inductive high-frequency pressure welding. According to the present technology, at least two different frequencies induced by at least one inductor are used for heating at least one connecting surface of the structural elements.

### RELATED APPLICATIONS

This application is a continuation of International Application No. PCT/DE2007/000454 (International Publication Number WO/2007/110037), having an International filing date of Mar. 14, 2007 entitled “Verfahren Zum Induktiven Hochfrequenzpresschweissverbinded Von Metallischen Bauelementen Unter Verwendung Mindestens Zweier Unterschiedlichen Frequenzen; Damit Hergestelltes Bauteil” (“Method For The Inductive High-Frequency Pressure Welding Of Metallic Structural Elements Using At Least Two Different Frequencies And Component Produced By Said Method”). International Application No. PCT/DE/2007/0004541 claimed priority benefits, in turn, from German Patent Application No. 10 2006 012 661.0, filed Mar. 20, 2006. International Application No. PCT/DE/2007/000454 and German Application No. 10 2006 012 661.0 are hereby incorporated by reference herein in their entireties.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present technology relates to a method for connecting metallic structural elements, especially structural elements of a gas turbine, whereby the connection of corresponding connecting surfaces of the construction elements occurs using inductive high-frequency pressure welding. The present technology also relates to a structural component produced by that method.

Various methods are known from the state of the art for connecting metallic structural elements by means of inductive high-frequency pressure welding. For example, DE 198 58 702 A1 describes a method for connecting blade parts of a gas turbine, whereby a blade vane section and at least one other blade part are prepared. In this case, corresponding connecting surfaces of these elements are positioned essentially flush with respect to each other and then welded together by excitation of an inductor with high-frequency current and by bringing them together with contact of their connecting surfaces. In this process, the inductor is excited at a constant frequency, which generally lies over 0.75 MHz. The frequency is also selected under consideration of the geometry of the connecting surfaces. With inductive high-frequency pressure welding, the adequately high and homogeneous heating of the two welding partners is of critical importance for the quality of the joining location. However, what is disadvantageous in the known methods is that only structural elements with cross sections less than 200 mm² can be welded to each other because with larger component cross sections, adequately high heating of the central and/or middle cross section area does not occur and thus no homogeneous heating of the joining points.

### BRIEF SUMMARY OF THE INVENTION

An object of the present technology is to provide a method of this general type for connecting metallic structural elements, in which a secure and permanent connection of structural elements with larger cross sections is ensured.

Another object of the present technology is to provide a component of this general type, especially a component of a gas turbine, whereby a secure and permanent connection is ensured between the individual structural elements.

These objects are achieved by a method according to the methods for connecting metallic structural components, and the components described herein.

To clarify, it is mentioned explicitly here that the term inductive high-frequency pressure welding does not define the method and/or the component in the present case at a specific frequency range. Rather, frequencies from the lower kHz range to the high MHz range are used so the new term inductive pressure welding (IPS) could also be introduced.

Advantageous embodiments of the present technology are described in the respective subclaims.

### BRIEF DESCRIPTION OF SEVERAL VIEWS OF THE DRAWINGS

Not Applicable

### DETAILED DESCRIPTION OF THE INVENTION

The presently described technology provides a method for connecting metallic structural elements, especially structural elements of a gas turbine. The method uses an inductive high-frequency pressure welding with warming of at least one connecting surface for connecting corresponding connection surfaces of the structural elements. During the process of inductive high-frequency pressure welding, at least two different frequencies induced by an inductor are used for heating the at least one connecting surface. Because of the use of at least two different frequencies, an optimal warming is ensured of the entire connecting surface and/or of the complete joining cross section for larger cross sections, especially from about 200 mm². In this way a secure and permanent connection between the individual structural elements is ensured. In this case, the edge areas of the connecting surface can be heated with a higher frequency and the inner-lying areas of the connecting surface can be heated with a lower frequency. The frequencies are selected in this process in relationship to the quality and geometry of the connecting surfaces. In addition, by using the method according to the present technology it is possible to securely and permanently connect construction elements with clearly different geometries of the connecting surfaces to each other since a homogeneous and simultaneous heating of the connecting surfaces to be connected to each other is ensured. Besides that, the simultaneous and homogeneous heating provides that there will be a uniform upsetting of the joining area so that a flawless welded connection can be achieved. The different frequencies used hereby can be induced by one inductor or by two or more of them.

In an advantageous embodiment of the method according to the present technology, the low frequency is selected from a range between 7 kHz to 1.0 MHz and the higher frequency is selected from the range between 1.0 to 2.5 MHz. For example, in this way it is possible to heat the thin edge area of a so-called blisk blade with a frequency of approx. 2 MHz and simultaneously to heat the maximum cross section in the center of the blade with a lower frequency in the range of 0.8 MHz.

In another advantageous embodiment of the method according to the presently described technology, the different frequencies act simultaneously or in succession on the at least one connecting surface. The multi-frequency technique according to the present technology can thus be tuned to different qualities and geometries of the metallic structural elements to be connected. In this process, the first and the second structural elements can consist of different or similar metallic materials. Structural elements that are of similar metallic materials but have been produced using different manufacturing methods can be securely and permanently connected.

In an advantageous embodiment of the method according to the present technology, the first structural element is a blade of a rotor in a gas turbine and the second element is a ring or a disk of the rotor. These components involve so-called blinks (“bladed ring”) or blisks (“bladed disk”) of gas turbine power plants.

A component according to the present technology, especially a component of a gas turbine, consists of a first structural element and a second structural element, whereby the first and the second structural elements are welded by means of an inductive high-frequency pressure welding. In this process, at least two different frequencies induced by at least one inductor are used during the process of inductive high-frequency pressure welding for warming at least one connecting surface of the structural elements. Because of this, it is possible to produce a component in which a secure and permanent connection of the individual structural elements to each other is ensured. In particular, the structural elements to be connected have relatively large cross section surfaces, especially greater than 200 mm². Even clearly different cross section surfaces of the first and second structural elements can be connected by the simultaneous and homogeneous heating of the joining cross sections of the connecting surfaces of the structural elements.

In this process, the first and second structural elements can consist of different or similar metallic materials. However, it is also possible for the first and second structural components to consist of similar metallic materials and be produced using different manufacturing methods. For example, this involves forged structural elements, structural element produced by casting methods, structural elements consisting of monocrystals or directionally solidified structural elements.

In another advantageous embodiment of the present technology, the first structural element is a blade of a rotor in a gas turbine and the second structural component is a ring or a disk of the rotor. These components involve so-called blinks (“bladed ring”) or blisks (“bladed disk” ) of gas turbine power plants.

The present technology has now been described in such full, clear, concise and exact terms as to enable a person familiar in the art to which it pertains, to practice the same. It is to be understood that the foregoing describes preferred embodiments and examples of the present technology and that modifications may be made therein without departing from the spirit or scope of the present technology as set forth in the claims. Moreover, while particular elements, embodiments and applications of the present technology have been shown and described, it will be understood, of course, that the present technology is not limited thereto since modifications can be made by those familiar in the art without departing from the scope of the present disclosure, particularly in light of the foregoing teachings and appended claims. Moreover, it is also understood that the embodiments shown in the drawings, if any, and as described above are merely for illustrative purposes and not intended to limit the scope of the present technology, which is defined by the following claims as interpreted according to the principles of patent law, including the Doctrine of Equivalents. Further, all references cited herein are incorporated in their entirety.

1. A method for connecting metallic structural elements, the method comprising connecting the corresponding connecting surfaces of the structural elements using high-frequency pressure welding, and heating at least one connecting surface of the structural elements, wherein the heating of at least one connecting surface is induced by at least one inductor using at least two different frequencies.

2. The method of claim 1, wherein the structural elements are structural elements of a gas turbine.

3. The method of claim 1, wherein the edge areas of the connecting surface are heated with a higher frequency, and the areas of the inner-lying areas are heated with a lower frequency.

4. The method of claim 3, wherein the frequencies are selected based on the quality and geometry of the connecting surfaces.

5. The method of claim 3, wherein the low frequency is selected from a range between 7 kHz-1.0 MHz and the higher frequency is selected from a range between 1.0-2.5 MHz.

6. The method of claim 4, wherein the low frequency is selected from a range between 7 kHz-1.0 MHz and the higher frequency is selected from a range between 1.0-2.5 MHz.

7. The method of claim 1, wherein the different frequencies act simultaneously or in succession on the at least one connecting surface.

8. The method of claim 3, wherein the different frequencies act simultaneously or in succession on the at least one connecting surface.

9. The method of claim 4, wherein the different frequencies act simultaneously or in succession on the at least one connecting surface.

10. The method of claim 5, wherein the different frequencies act simultaneously or in succession on the at least one connecting surface.

11. The method of claim 6, wherein the different frequencies act simultaneously or in succession on the at least one connecting surface.

12. The method of claim 1, wherein the connected structural elements are composed of different metallic materials.

13. The method of claim 3, wherein the connected structural elements are composed of different metallic materials.

14. The method of claim 1, wherein one of the connected structural elements is a blade of a rotor in a gas turbine and another connected structural element is at least one of a ring or a disk of the rotor in the gas turbine.

15. The method of claim 3, wherein one of the connected structural elements is a blade of a rotor in a gas turbine and another connected structural element is at least one of a ring or a disk of the rotor in the gas turbine.

16. A component of a gas turbine comprising a first structural element welded to a second structural element using inductive high-frequency pressure welding, wherein at least one connecting surface of the structural elements has been heated by an inductor that induced at least two different frequencies.

17. The component of claim 16, wherein the first and the second structural elements are composed of different or similar metallic materials.

18. The component of claim 16, wherein the first structural element is a blade of a rotor in a gas turbine and the second structural elements is at least one of a ring or a disk of the rotor in the gas turbine.

19. The component of claim 17, wherein the first structural element is a blade of a rotor in a gas turbine and the second structural elements is at least one of a ring or a disk of the rotor in the gas turbine.
